(19) United States
(12) Patent Application Publication
(10) Pub. No.: US 2014/0299433 A1
(43) Pub. Date: Oct. 9, 2014

(54) Transmission Unit

(71) Applicant: Voith Patent GmbH, Heidenheim (DE)

(72) Inventor: Werner Adams, Crailsheim (DE)

(21) Appl. No.: 14/237,547

(22) PCT Filed: Jun. 5, 2013
(86) PCT No.: PCT/EP2013/061608

§ 371 Date: Jun. 2, 2014

(30) Foreign Application Priority Data
Jun. 15, 2012 (DE) 10 2012 011 766.3

(51) Int. Cl. F16D 47/06

(52) U.S. Cl. CPC F16D 47/06
USPC 192/3.28

(57) ABSTRACT

The invention relates to a transmission unit for coupling a running wheel of a hydrodynamic component to a drive element having:—a running wheel shaft directly connected to the running wheel;—a first coupling device, provided with a synchroelement, to connect an intermediate shaft, indirectly connected to the running wheel, to the drive element; The invention is characterised in that:—a second coupling device, provided with a synchroelement, is provided for at least indirect connection of the running wheel shaft to the drive element; and—the running wheel shaft and the intermediate shaft are in single-sided drive connection via a free wheel.

The invention relates to a transmission unit for coupling a blade wheel of a hydrodynamic component to a drive element according to the preamble of claim 1. The invention further relates to a method for coupling a blade wheel of a hydrodynamic component to a drive train by means of such a transmission unit.

The invention concerns a transmission unit for coupling and for the releasable connection of a blade wheel of a hydrodynamic component to a drive unit, e.g. a drive element which is driven by a drive train. The invention especially concerns a transmission unit for coupling a disconnectable retarder as a hydrodynamic component to a drive element which is connected to the drive train of a motor vehicle, especially a commercial vehicle.

DE 10 2010 028 077 A1 describes a method for the shift control of a semiautomatic gearbox. It is provided upstream with a hydrodynamic starting and braking element which is provided with a pump wheel and a turbine wheel. It is provided for reducing the shifting sequence that the braking of the input shaft is commenced via a transmission-internal synchronizing device already during the braking of the turbine wheel via the turbine brake with a previously determined time delay after the activation of the turbine brake.

The transmission-internal synchronizing device is triggered during the braking of the input shaft in such a way that the input shaft does not substantially fall beneath a predetermined minimum speed difference in relation to the turbine wheel up until reaching a predetermined reference speed by the turbine wheel.

A method for controlling a hydrodynamic brake is known from EP 2 024 209 B1. The hydrodynamic component described there in form of a hydrodynamic retarder is connected via a mechanical coupling device with a synchroelement when required to a driven shaft which needs to be braked. The problem in this configuration is that especially when the hydrodynamic component is already filled with working medium during the closing, of the coupling device or is filled with working medium during the closing of the coupling device the coupling device needs to provide a comparatively high level of synchronization work because the at least one rotatably movable component in the working chamber of the hydrodynamic components will offer considerable resistance to the switch from the standstill to the driven state. The synchronization energy needs to be generated by the coupling device, which is thus highly loaded, leading to increased wear and tear of the mechanical coupling device or its synchroelement.

It is the object of the present invention to provide a transmission unit for coupling a blade wheel of a hydrodynamic component to a drive element which avoids these disadvantages and offers a simple and efficient possibility for transmitting high synchronization power. Furthermore, it is the object of the present invention to provide a method for coupling a blade wheel of a hydrodynamic component to a drive train by means of such a transmission unit.

This object is achieved in accordance with the invention by a transmission unit with the features in the characterizing part of claim 1. Furthermore, this object is achieved by the method described in claims 11 and 12. Advantageous embodiments and further developments of the transmission unit in accordance with the invention are provided in the dependent sub-claims.

The transmission unit in accordance with the invention for coupling the blade wheel of a hydrodynamic component to a drive element provides that an intermediate shaft which is indirectly connected to the blade wheel is connectable to the drive element via a first coupling device with a synchroelement, and that via a second coupling device provided with

[symbol]

element, and that further the blade wheel shaft and the intermediate shaft are in a single side drive connection via a freewheel. The two coupling devices with the synchroelements can transmit the power either in parallel or in series in the transmission unit in accordance with the invention depending on the constructional configuration in detail, wherein potential differences in speed in one direction can be compensated by the freewheel. This ensures that the blade wheel shaft—if it already rotates at a higher speed than the intermediate shaft—is not driven but runs “freely” in relation to the intermediate shaft.

In the transmission unit in accordance with the invention, several synchronizable drives acting in the same direction are switched in parallel or in series in succession and optionally with different speed-transforming gears to a driveable blade wheel shaft to be coupled, which on its part is connected to the blade wheel of the hydrodynamic component. The drives are connected to each other or separated from each other via a freewheel or—in the case of several different speed steps—several freewheels. The number of freewheels is respectively lower by one than the number of the different speeds steps.

The different drives can be optimized by means of the different speed-transforming gears to their respective task. For example, a first coupling element arranged with a synchroelement and comprising a speed-transforming gear of high torque can break away the blade wheel to be driven or the blade wheel of the hydrodynamic component to be driven against a high breakaway torque, or in the case of an arrangement of the hydrodynamic component as a retarder it can discharge the same against high system pressure. The breakaway blade wheel can be accelerated by a high-speed speed-transforming gear to the target speed by at least one further coupling element with a synchroelement. The two coupling devices with their synchroelements share the entire occurring shifting work or synchronizing work, but are also capable of jointly transmitting a multiple of the synchronizing torque to the blade wheel of the hydrodynamic component to be accelerated, so that in the case of a selectable or disconnectable retarder any potential residual filling of the retarder with working medium can be compensated very easily.

Depending on the preferred application, the constructional configuration can be adjusted accordingly. It can therefore be provided according to a highly advantageous further development of the transmission unit in accordance with the invention that the blade wheel shaft is

[symbol]

intermediate shaft is connectable on its part via the first coupling device with the synchroelement to the drive element, so that a serial configuration is obtained in its entirety in which ideally the first coupling element and thereupon the second coupling element are switched successively.

It can be provided in an alternative embodiment however that the blade wheel shaft is connected to the drive element via the second coupling device. Such a configuration, in which the blade wheel shaft is connectable to the drive element parallel to the intermediate shaft via the second coupling device, represents in its entirety a parallel configuration of the two coupling devices provided with the synchroelements. It is able to transmit a very high synchronizing torque.

It can further be provided in a further, highly advantageous embodiment of the configuration in accordance with the invention that the second coupling device is connected to the blade wheel shaft by a transmission, especially a planetary gear. This configuration, in which the power flowing via the second coupling device is injected via a transmission to the blade wheel shaft, further allows the use of a speed-transforming gear, optionally a speed-transforming gear deviating from an optional transmission in the region of the other power branch, in order to thus enable ideally fulfilling the different tasks as already described above.

It is also provided in a further, highly advantageous embodiment of the transmission unit in accordance with the invention that at least one transmission is arranged in the single-side drive connection between the blade wheel shaft and the intermediate shaft. Such a

transmission in this region can be arranged either before and/or after the freewheel and also allows in this case setting a purposeful gear ratio between the blade wheel shaft and the intermediate shaft or the freewheel.

It is also provided in a further highly advantageous embodiment of the transmission unit in accordance with the invention that the first and the second coupling device can be actuated via a common actuator. Such a common actuator for actuating both coupling devices provides the transmission unit with a respectively simple and efficient configuration, because the actuating system required for actuation can be reduced considerably. The actuator

[symbol]

mechanical coupling that the second coupling device is switched accordingly only after the first coupling device, especially after the slip-free engagement of the first coupling device.

The two methods for coupling a hydrodynamic component to a drive train by means of such a transmission unit in accordance with the invention respectively provide according to configuration and application that according to the first method in accordance with the invention the first coupling device provided with a synchronizing element is closed first until it is in slip-free engagement, whereupon the second coupling device provided with a synchronizing element is closed. This method divides the shifting work among the two coupling devices with their synchronizing elements. They can fulfill different requirements for example and can be provided with an optimized configuration concerning the torque on the one hand and concerning the speed on the other hand. The method is ideally arranged in such a way that the first coupling device is switched accordingly until it is in slip-free engagement or—if mechanical locking occurs after a synchronization—until the mechanical connection has been produced. Once this slip-free connection has been produced (it is also generally referred to that the coupling device is “switched through”), the second coupling device is actuated so that they respectively share the switching work.

It is provided however in the alternative method that the first and the second coupling devices with their synchroelements are actuated simultaneously. Such a simultaneous actuation of both coupling devices distributes the synchronizing work among both coupling devices, so that they are capable of jointly transmitting a much higher synchronizing torque. In combination with a very simple and compact configuration, a very high torque can be transmitted in this manner in order to switch a retarder that has already been filled with working medium as a hydrodynamic component to a drive element.

Further advantageous embodiments of the transmission unit in accordance with the invention and the method in accordance with the invention are provided from the embodiments which will be explained below in closer detail by reference to the drawings, wherein:

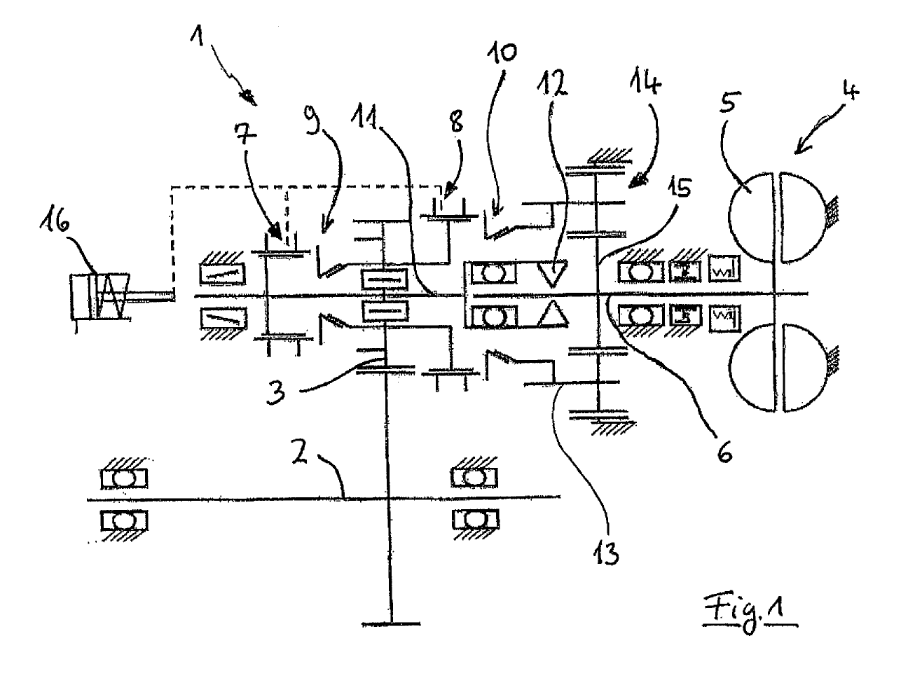

FIG. 1 shows a two-step transmission unit which is mechanically switched in parallel and comprises a speed-increasing ratio by means of a planetary gear;

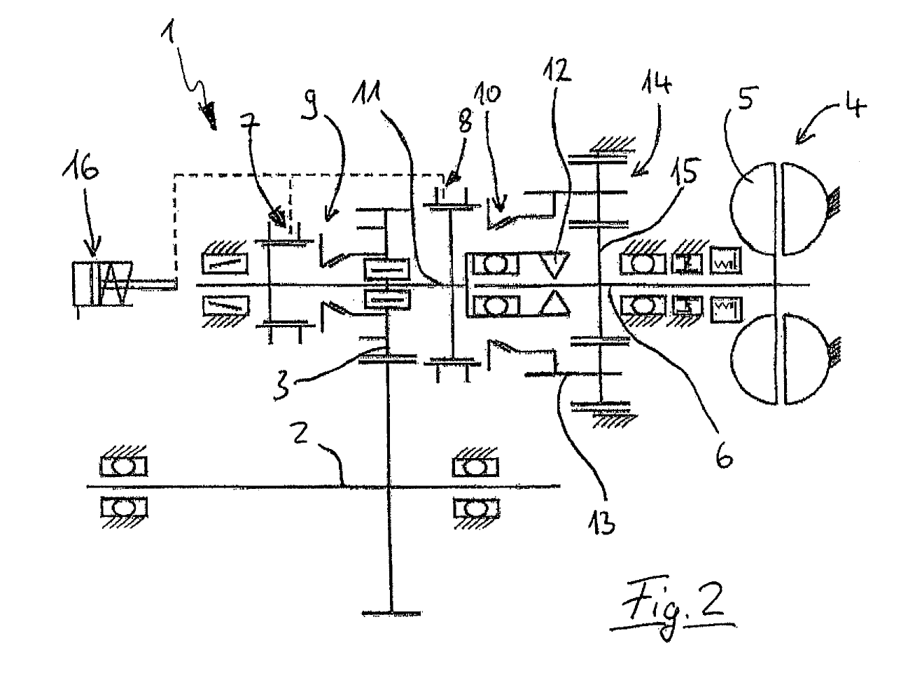

FIG. 2 shows a two-step transmission unit which is mechanically switched in series and comprises a speed-increasing ratio by means of a planetary gear;

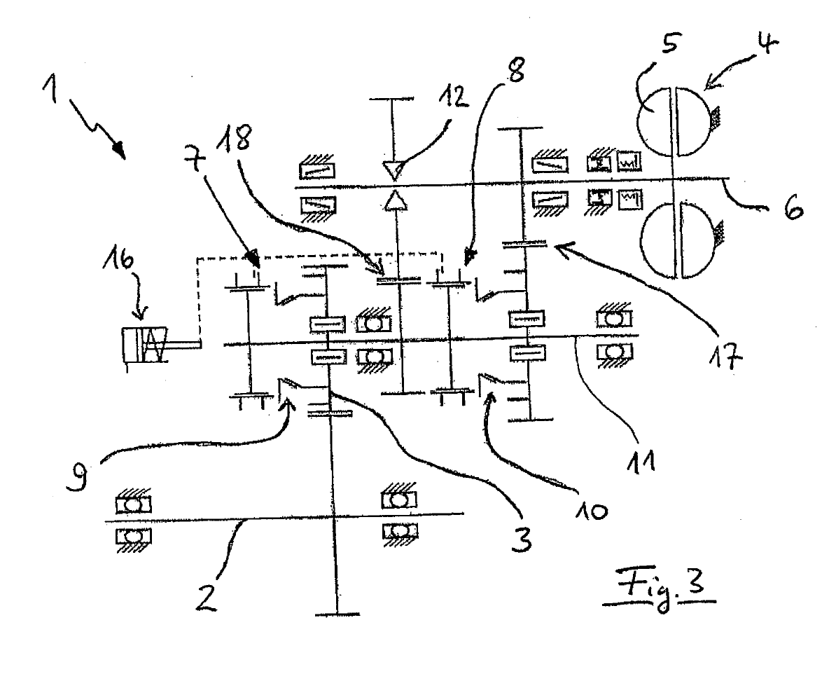

FIG. 3 shows a two-step transmission unit which is mechanically switched in series and comprises a double spur-gear unit;

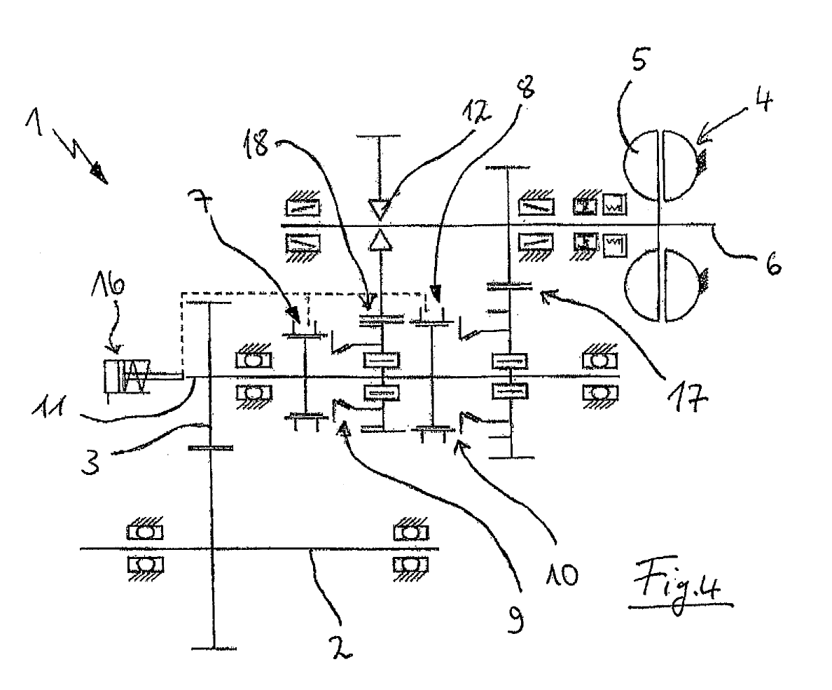

FIG. 4 shows a two-step transmission unit which is mechanically switched in parallel and comprises a double spur-gear unit, and

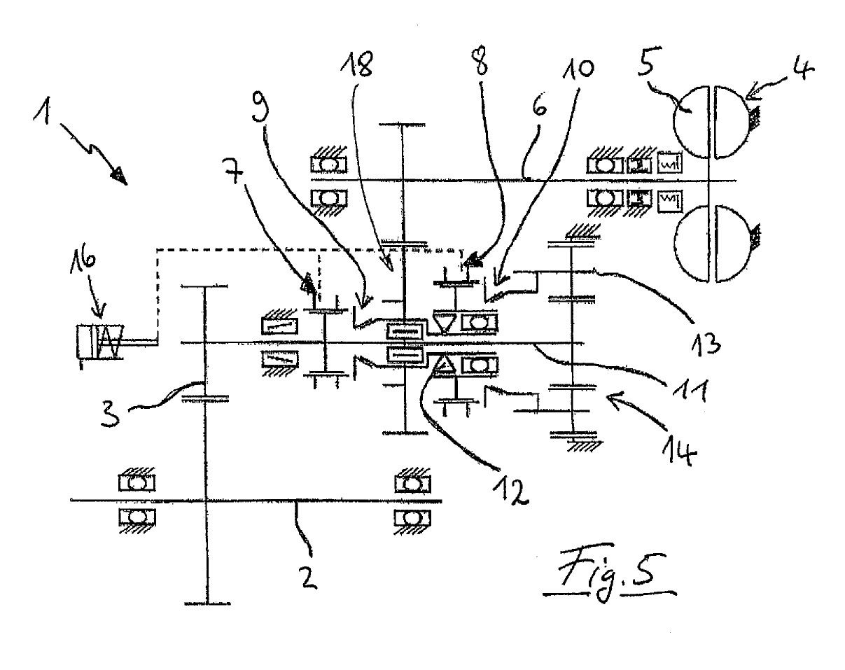

FIG. 5 shows a two-step transmission unit which is mechanically switched in parallel and comprises a speed-decreasing ratio by means of a planetary gear.

The schematic illustration of FIG. 1 shows a first possible embodiment of a transmission unit 1 according to the invention.

The transmission unit 1 is driven via a drive train, of which a shaft 2 with a gear wheel is indicated here by way of example. It may concern a power take-off on a transmission of a commercial vehicle for example. The shaft 2 can be connected to a hydrodynamic component 4 via the transmission unit 1 by way of a drive element 3 of the transmission unit 1 arranged as a gearwheel. The hydrodynamic component 4 especially concerns a retarder. A blade wheel 5 of the retarder 4, which is directly connected to a blade wheel shaft 6, is connected when necessary via the transmission unit 1 to the shaft 2 of the drive train and therefore brakes said shaft. The configuration shall merely be understood as an example. Instead of the retarder 4 it would also be possible to use another hydrodynamic component 4 or any other configuration of a hydrodynamic retarder, e.g. with a freewheeling stator which is fixedly braked only when required. Two coupling devices 7, 8 are provided for connecting the drive element 3 to the blade wheel shaft 6 and thus the blade wheel 5 of the retarder 4, which coupling devices respectively comprise a synchroelement 9, 10. The drive element 3 can be connected to an intermediate shaft 11 via the first coupling device 7 with the synchroelement 9, which intermediate shaft is in single-side drive connection to the blade wheel shaft 6 by a freewheel 12. If the intermediate shaft 11 is driven faster than the blade wheel shaft 6 is already running, a drive connection occurs. In all other cases, the blade wheel shaft 6 can resolve “freely”.

A connection of the drive element 3 to the blade wheel shaft 6 can also be realized in the embodiment shown here via the second coupling device 8 with its synchroelement 10. For this purpose, a slip-free connection between the drive element 3 and a planet carrier 13 of a planetary gear 14 is produced for this purpose after synchronization. In the case of a fixed outer rim or ring gear, the drive connection is then realized between the planet carrier 3 and the-sun 15 of the planetary gear 14 which is connected in a torque-proof manner to the blade wheel shaft 6.

Both coupling devices 7, 8 can preferably be actuated via a single common actuator 16, for which purpose it actuates the two coupling devices 7, 8 either in parallel and simultaneously, so that the occurring synchronizing work is divided between the two synchroelements 9, 10. It is also alternatively possible by way of control and/or via a mechanical coupling of the coupling devices 7, 8 to switch them via an actuator 16 in such a way that the first coupling device 7 is switched first and, once it has switched through, the other coupling device 8 is switched. In this manner of switching the transmission unit 1, the synchronizing work can also be divided between the coupling devices 7, 8 and its synchroelements 9, 10, especially in such a way that different requirements can be fulfilled by each of the coupling devices 7, 8. A breakaway of the blade wheel 5 against a breakaway torque or an optionally at least partly filled working chamber of the retarder 4 can be achieved for example via the first coupling device and a high-torque speed-transforming gear, whereas afterwards a rapid speed increase of the blade wheel 5 to the target speed is realized via a high-torque speed-transforming gear in the region of the planetary gear 14. Such operation is easily possible as a result of the freewheel between the intermediate shaft 11 and the blade wheel shaft 6.

The following FIGS. 2 to 5 substantially show the same configuration with comparable functionality and the possibility of parallel or serial actuation of the two coupling element 7, 8. The drawings differ from each other in the specific configuration concerning the choice of the employed transmission elements and the mechanic parallel or serial switching of the coupling devices 7, 8. Only the differences of the individual drawings in comparison with the preceding drawings will be discussed below in detail, while the fundamental functionality will not be explained again.

The relevant difference in the transmission unit 1 shown in FIG. 2 is that the second coupling

[symbol]

the planetary gear 14 connected to the blade wheel shaft 6, but in such a way that the intermediate shaft 11 can be coupled to the planet carrier 13 of the planetary gear 14. This substantially leads to a serial power flow, because the intermediate shaft 11 will only be supplied with power when the first coupling device 7 is already in engagement or is switched through in particular. In all other aspects, the configuration of the transmission unit 1 as shown in FIG. 2 corresponds to the configuration as shown in FIG. 1.

The configuration explained in connection with FIG. 2 will be discussed again in the illustration in FIG. 3, wherein the planetary gear 14 is omitted as the first distinct difference. A spur-gear unit 17 is provided instead of the planetary gear 14, which produces a respective connection between the intermediate shaft 11 and the blade wheel shaft 6 via the second coupling device 8, similar to the illustration in FIG. 2. A further difference is provided in a further spur-gear unit 18, which is arranged between the blade wheel shaft 6 and the connection of said blade wheel shaft 6 via freewheel 12 to the intermediate shaft 11. A respective transformation of the speeds between the two shafts 6, 11 in the single-side drive connection which is realized by the freewheel 12 is also made in this case via the transmission.

The configuration shown in Fig. 4 uses this configuration again and now realizes a parallel arrangement of the two coupling devices 7, 8 similar to the embodiment shown in Fig. 1. The intermediate shaft 11 is connected in a torque-proof manner to the drive element 3 for this purpose and can be coupled on its part via the first coupling device 7 and the further spur-gear unit 18 to the intermediate shaft 6, and can respectively be coupled on the other hand via the second coupling device 8 and the spur-gear unit 17 to the blade wheel shaft 6 in parallel thereto without the freewheel 12.

In the illustration of FIG. 5, the spur-gear unit 17 is replaced on the other hand by the planetary gear 14, wherein the link-up of the intermediate shaft 11 that is rigidly connected to the drive unit 3 occurs directly via the further spur-gear unit 18 and the first coupling device 7, whereas the connection between the intermediate shaft 11 and the blade wheel shaft 6 occurs in the illustrated embodiment by the freewheel 12 and the planetary gear 14, similar to the illustration in Fig. 1. The only difference in this case is that the speed-transforming ratio is decreased by the planetary gear 14 instead of increased as shown in

[symbol]

The transmission units 1 shown in FIGS. 1 to 5 shall be understood as exemplary embodiments for the transmission units 1 in accordance with the invention. Other constructional configurations are obviously also included in the idea of the invention, as also the constructional configurations of the embodiments shown herein.

1-12. (canceled)

13: A transmission unit for coupling a blade wheel of a hydrodynamic component to a drive element, the transmission unit comprising:
a blade wheel shaft that is directly connected to the blade wheel; and
a first coupling device provided with a synchroelement for the connection of the drive element to an intermediate shaft connected indirectly to the blade wheel;
wherein a second coupling device having a synchroelement is provided for the at least indirect connection of the blade wheel shaft to the drive element, and the blade wheel shaft and the intermediate shaft are in single-side drive connection via a freewheel.

14: The transmission unit according to claim 13, wherein the blade wheel shaft is connectible to the intermediate shaft via the second coupling device.

15: The transmission unit according to claim 13, wherein the blade wheel shaft is connectible to the drive element via the second coupling device.

16: The transmission unit according to claim 13, wherein the second coupling device is connected to the blade wheel shaft via a gear.

17: The transmission unit according to claim 14, wherein the second coupling device is connected to the blade wheel shaft via a gear.

18: The transmission unit according to claim 15, wherein the second coupling device is connected to the blade wheel shaft via a gear.

19: The transmission unit according to claim 16, wherein the gear is arranged as a planetary gear.

20: The transmission unit according to claim 17, wherein the gear is arranged as a planetary gear.

21: The transmission unit according to claim 18, wherein the gear is arranged as a planetary gear.

22: The transmission unit according to claim 13, wherein at least one gear is arranged in the single-side drive connection between the blade wheel shaft and the intermediate shaft.

23: The transmission unit according to claim 14, wherein at least one gear is arranged in the single-side drive connection between the blade wheel shall and the intermediate shaft.

24: The transmission unit according to claim 15, wherein at least one gear is arranged in the single-side drive connection between the blade wheel shaft and the intermediate shaft.

25: The transmission unit according to claim 16, wherein at least one gear is arranged in the single-side drive connection between the blade wheel shaft and the intermediate shaft.

26: The transmission unit according to claim 17, wherein at least one gear is arranged in the single-side drive connection between the blade wheel shaft . and the intermediate shaft.

27: The transmission unit according to claim 13, wherein the first coupling device and the second coupling device can be actuated via a common actuator.

28: The transmission unit according to claim 27, wherein the first coupling device and the second coupling device are mechanically coupled to each other in such a way that the second coupling device is actuated only after the actuation of the first coupling device.

29: The transmission unit according to claim 27, wherein the first coupling device and the second coupling device are mechanically coupled to each other in such a way that the first coupling device and the second coupling device are actuated simultaneously.

30: The transmission unit according to claim 13, wherein the hydrodynamic component is arranged as a hydrodynamic retarder.

31: A method for coupling a blade wheel of a hydrodynamic component in a drive train using a transmission unit for coupling a blade wheel of a hydrodynamic component to a drive element, where the transmission unit includes a blade wheel shaft that is directly connected to the blade wheel, and a first coupling device provided with a first synchroelement for the connection of the drive element to an intermediate shaft connected indirectly to the blade wheel, wherein a second coupling device having a second synchroelement is provided for the at least indirect connection of the blade wheel shaft to the drive element, and the blade wheel shaft and the intermediate shaft are in single-side drive connection via a freewheel, the method comprising:
closing the first coupling device provided with the first synchroelement until in slip-free engagement, whereupon closing the second coupling device provided with the second synchroelement.

32: A method for coupling a blade wheel of a hydrodynamic component in a drive train using a transmission unit for coupling a blade wheel of a hydrodynamic component to a drive element, where the transmission unit includes a blade wheel shaft that is directly connected to the blade wheel, and a first coupling device provided with a first synchroelement for the connection of the drive element to an intermediate shaft connected indirectly to the blade wheel, wherein a second coupling device having a second synchroelement is provided for the at least indirect connection of the blade wheel shaft to the drive element, and the blade wheel shaft and the intermediate shaft are in single-side drive connection via a freewheel, the method comprising:
simultaneously actuating the first synchroelement of the first coupling device and the second synchroelement of the second coupling device.
